(19) United States
(12) Patent Application Publication
(10) Pub. No.: US 2026/0177824 A1
(43) Pub. Date: Jun. 25, 2026

(54) MOLDED ONE-DIMENSIONAL EXPANDER FABRICATION APPROACHES

(71) Applicant: GOOGLE LLC, Mountain View, CA (US)

(72) Inventors: Kang Luo, San Jose, CA (US); Ozan Cakmakci, San Bruno, CA (US); Oscar Alberto Martinez, San Diego, CA (US)

(21) Appl. No.: 18/989,477

(22) Filed: Dec. 20, 2024

(51) Int. Cl. G02B 27/01

(52) U.S. Cl. CPC G02B 27/0172; G02B 2027/0123

(57) ABSTRACT

A lightguide includes a one-dimensional (1D) expander configured to expand light within the lightguide along a first axis perpendicular to a second axis associated with the light, and increase a size of an exit pupil. The 1D expander includes a first portion having a first patterned surface and a second portion having a second patterned surface. A reflective coating is formed on selected portions of at least one of the first patterned surface or the second patterned surface. A first filler layer is formed on a world-side surface of the first portion, and a second filler layer is formed on an eye-side surface of the second portion. A first indexed-matched adhesive layer is disposed between the first filler layer and the world-side surface of the first portion, and a second indexed-matched adhesive layer is disposed between the second filler layer and the eye-side surface of the second portion.

### BACKGROUND

A flat waveguide is a planar optical structure designed to guide light across its thin surface using principles such as total internal reflection. These waveguides are implemented in various modern optical systems, such as in augmented reality (AR) and mixed reality (MR) devices, where they deliver and manipulate light from a display source to the user's eyes. The compact and lightweight nature of flat waveguides allows them to combine several optical functions, such as expanding light paths, redirecting beams, and projecting images within a single, slim form factor. This makes flat waveguides desirable for wearable technology, where minimizing size and weight is desired.

Despite their advantages, flat waveguides face different challenges that limit their widespread adoption. For example, energy efficiency remains a hurdle, with current designs struggling to achieve the performance needed for all-day wearable use. Additionally, manufacturing these systems can be costly and prone to low yields, complicating scalability. Other issues include difficulties in integrating prescription lenses seamlessly, as well as problems related to aesthetics, such as light leakage and visible artifacts.

### SUMMARY OF EMBODIMENTS

In accordance with one aspect, a method of forming a one-dimensional (1D) expander includes forming a first portion and a second portion of the 1D expander, wherein the first portion comprises a first patterned surface and the second portion comprises a second patterned surface complementary to the first patterned surface, applying a reflective coating to selected portions of at least one of the first patterned surface or the second patterned surface, depositing an index-matched adhesive on at least one of the first patterned surface or the second patterned surface, and bonding the first portion and the second portion together using the index-matched adhesive.

In at least some embodiments, forming the first portion and second portion includes molding the first portion and the second portion from an optical-grade polymer material.

In at least some embodiments, applying the reflective coating includes applying the reflective coating to facets of the at least one of the first patterned surface or the second patterned surface.

In at least some embodiments, the method further includes bonding a first filler material on a first surface of the first portion and bonding a second filler material on a second surface of the second portion.

In accordance with one aspect, a method of forming a one-dimensional (1D) expander includes forming a first portion of the 1D expander by casting or molding the first portion, wherein the first portion comprises a first patterned surface, applying a reflective coating to selected portions of the first patterned surface of the first portion, and forming a second portion of the 1D expander directly on the first portion by overcasting or over-molding a second patterned surface complementary to the first patterned surface onto the first portion.

In at least some embodiments, forming the first portion includes molding the first portion from an optical-grade polymer material.

In at least some embodiments, applying the reflective coating includes applying the reflective coating to facets of the first patterned surface.

In at least some embodiments, the method further includes bonding a first filler material on a first surface of the first portion via a first indexed-matched adhesive layer and bonding a second filler material on a second surface of the second portion via a second indexed-matched adhesive layer.

In a further aspect, a lightguide includes a one-dimensional (1D) expander configured to expand light within the lightguide along a first access perpendicular to a second axis associated with the light, and further configured to increase a size of an exit pupil. The 1D expander includes a first portion having a first patterned surface, a second portion having a second patterned surface complementary to the first patterned surface, a reflective coating formed on selected portions of at least one of the first patterned surface or the second patterned surface, the reflective coating configured to reflect light within the lightguide, a first filler layer formed on a world-side surface of the first portion, a second filler layer formed on an eye-side surface of the second portion, a first indexed-matched adhesive layer between the first filler layer and the world-side surface of the first portion, and a second indexed-matched adhesive layer between the second filler layer and the eye-side surface of the second portion.

In at least some embodiments, a near-eye display device includes the lightguide described herein and further includes a support structure, a lens supported by the support structure, the lens implementing the lightguide, and a light engine configured to project display light for incoupling into the lightguide.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of an example display system including a lightguide assembly implementing one or more one-dimensional (1D) expanders in accordance with some embodiments.

FIG. 2 is a diagram of a projection system that projects images directly onto the eye of a user via display light in accordance with some embodiments.

FIG. 3 is one example of a fabrication process for forming a 1D expander in accordance with some embodiments.

FIG. 4 is another example of a fabrication process for forming a 1D expander in accordance with some embodiments.

FIG. 5 is a diagram of a lightguide and a 1D expander formed according to the fabrication process of either FIG. 3 or FIG. 4 in accordance with some embodiments.

FIG. 6 is a perspective view of an eyeglass lens assembly incorporating a 1D expander formed according to the fabrication process of either FIG. 3 or FIG. 4 with multiple reflective coatings embedded in the central region of the lens structure in accordance with some embodiments.

### DETAILED DESCRIPTION

Flat waveguide architectures are an emerging technology explored for applications in augmented reality, mixed reality, and other wearable display systems. These systems are designed to integrate advanced optical functionality within compact form factors, ideally for all-day wearable use. Despite their potential, various challenges persist in areas such as optical performance, aesthetic design, manufacturing scalability, durability, and prescription lens integration.

Optically, the energy efficiency of existing flat waveguide solutions is well below the desired threshold for practical all-day battery life, often operating for less than one hour under current specifications. Additionally, achieving uniform color rendering remains a hurdle, as noticeable differences in color consistency can detract from the user experience. From a cosmetic perspective, issues such as light leakage, internal lens reflections, diffractive artifacts, and visible structures within the lens compromise both aesthetic appeal and user privacy. Moreover, the thickness and appearance of the lens stack, particularly when incorporating prescription (Rx) functionality, remain areas of concern.

Manufacturing these waveguides also faces significant cost and scalability challenges. Advanced techniques, such as those used in semiconductor fabrication or the production of reflective two-dimensional (2D) waveguides, often result in low yield or prohibitively high costs, limiting mass adoption. Reliability is another limitation. While glass-based systems offer certain optical advantages, they often fail durability tests, such as the ball drop test. Integrating prescription lenses into these systems compounds the challenges. For example, current implementations often rely on a triple-stack design, introducing asymmetry between the left and right lenses, raising standards and compliance questions, and adding to cosmetic and reliability concerns due to high reflectivity and the structural complexity of multiple layers.

As such, the following describes embodiments of systems and methods for implementing a one-dimensional (1D) molded expander approach to address challenges in fabricating waveguides, such as curved plastic lightguides. The approaches described herein focus on, for example, improving uniformity, efficiency, manufacturing simplicity, and the like. In at least some embodiments, the 1D expander leverages a first axis expanding prism array, minimizing optical interactions compared to 2D alternatives, and achieves superior performance with an improved nonuniformity deviation. For instance, in a typical device orientation, the first axis corresponds to the horizontal direction, allowing the prism array to expand light horizontally. By employing index-matching techniques, this approach eliminates the need for polishing top and bottom facets, significantly reducing fabrication complexity and cost.

In at least some embodiments, the expander is fabricated using a technique that includes molding, partial mirror coating, glue dispensing, and bonding prism arrays to form the expander. In other embodiments, the expander is fabricated using another technique that includes casting or molding to create the bottom prism, partial mirror coating, and overcasting or over-molding to complete the expander. Both techniques address issues caused by differential cooling, such as sink marks, by eliminating polishing steps through the use of index-matched adhesives.

The 1D expander, in at least some embodiments, is integrated into an eyepiece system resembling eyeglasses. This process includes, for example, bonding the expander with a lightguide and applying world-side filler and eye-side filler. Low-index coatings on the fillers create a cladding layer for total internal reflection, which enables the embedding of partial reflectors inside regular eyeglasses. Components are bonded with index-matched adhesive and thicker molded fillers can be resurfaced during assembly to accommodate manufacturing tolerances. This configuration ensures high optical quality within a compact eyeglass frame, offering a practical and efficient solution for advanced optical systems.

As used herein, the term “first axis” refers to the primary direction along which the 1D expander operates to expand light within the lightguide assembly. This axis is orthogonal to the second axis and defines the direction of light expansion relative to the device's default functional orientation. For example, in a typical device orientation, the first axis may correspond to the horizontal direction, wherein “horizontal” is understood to be parallel to the horizon and orthogonal to the direction of gravity. However, the embodiments described herein are not limited to this orientation and can be adapted to various configurations as needed.

The term “second axis” refers to the secondary direction perpendicular to the first axis within the lightguide assembly. This axis defines the direction orthogonal to the first axis, ensuring two-dimensional light manipulation without specifying any physical orientation of the device. For instance, in a typical device orientation, the second axis may correspond to the vertical direction, wherein “vertical” is understood to be perpendicular to the horizon and aligned with the direction of gravity. However, the second axis can assume different orientations based on the device's configuration.

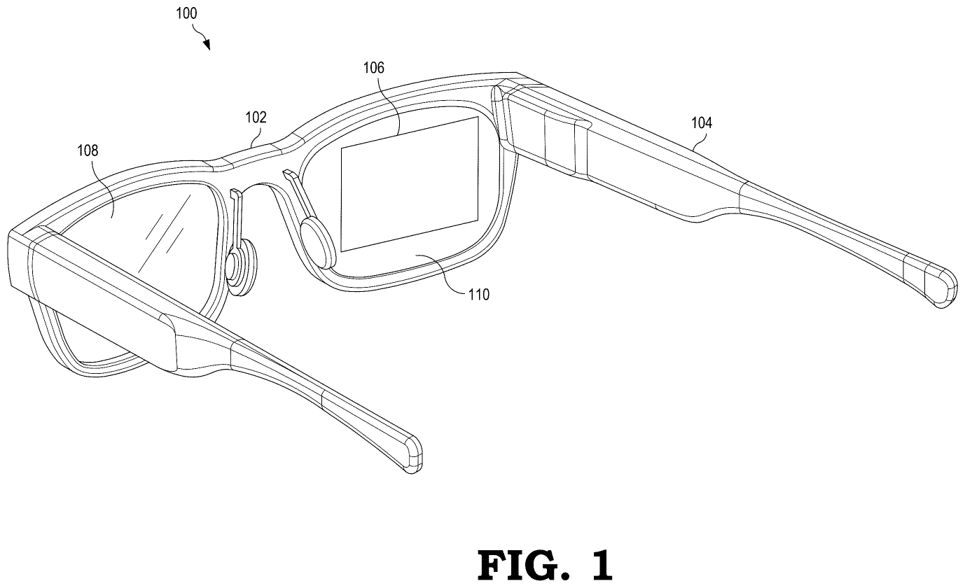

FIG. 1 illustrates an example display system 100 having a support structure 102 that includes an arm 104, which houses a projection system configured to project display light representative of images toward the eye of a user, such that the user perceives the images as being displayed in an FOV area 106 of a display at one or both of lens elements 108, 110. In the depicted example, the display system 100 is an HWD or other near-eye display (NED) that includes a support structure 102 configured to be worn on the head of a user and has a general shape and appearance of an eyeglasses frame or sunglasses frame. The support structure 102 contains or otherwise includes various components to facilitate the projection of such images toward the eye of the user, such as a projector (e.g., optical engine) and a lightguide.

In at least some embodiments, the support structure 102 further includes various sensors, such as one or more front-facing cameras, rear-facing cameras, other light sensors, motion sensors, accelerometers, and the like. The support structure 102 can further include one or more radio frequency (RF) interfaces or other wireless interfaces, such as a Bluetooth interface, a Wi-Fi interface, and the like. Further, in at least some embodiments, the support structure 102 includes one or more batteries or other portable power sources for supplying power to the electrical components of the display system 100. In at least some embodiments, some or all of these components of the display system 100 are fully or partially contained within an inner volume of support structure 102, such as within the arm 104 in a region of the support structure 102. It should be noted that while an example form factor is depicted, it will be appreciated that in other embodiments, the display system 100 may have a different shape and appearance from the eyeglasses frame depicted in FIG. 1.

One or both of the lens elements 108, 110 are used by the display system 100 to provide, for example, an extended reality (XR) display in which rendered graphical content can be superimposed over or otherwise provided in conjunction with a real-world view as perceived by the user through the lens elements 108, 110. Display light used to form a perceptible image or series of images is projected by a light engine of the display system 100 and routed through a lightguide incorporating a one-dimensional (1D) expander, which is described in greater detail below. In at least some embodiments, the 1D expander functions as an exit pupil expander (EPE), achieving pupil expansion and enhanced luminance uniformity by expanding light along a first axis via a prism array. In a typical device orientation, this first axis corresponds to the horizontal direction, allowing the prism array to effectively expand light horizontally. This expansion enables a wider and more uniform viewing area. The lightguide directs the display light toward the user's eye, allowing the user to view the image within the FOV of the display system 100.

For example, the light engine emits display light that is representative of an image, such that the display light forms an exit pupil near the light engine output. The display light then travels to the incoupler of the lightguide, which directs the light into the body of the lightguide. The light propagates through the lightguide via total internal reflection (TIR), partial internal reflection (PIR), or both. To achieve uniform distribution and a wider eyebox, the light passes through the 1D expander. The 1D expander is fabricated using techniques such as molding or casting with partial mirror coatings and index-matched adhesives, thereby reducing manufacturing complexities while maintaining high optical performance. The embedding of the 1D expander using an index-matched low-index coating or adhesive removes the additional polishing steps of conventional techniques.

In at least some embodiments, the 1D expander replaces or works in conjunction with an outcoupler to expand the light along the first axis, effectively increasing the eyebox size. By doing so, the pupil is formed in the middle of the glasses rather than at the incoupler, allowing for a large viewing area (e.g., 10 mm×10 mm or another dimension) both along the first axis (e.g., horizontally) and the second axis (e.g., vertically). The components of the lightguide, including the expander, are designed to minimize reflection and optimize efficiency, ensuring high-quality optical performance in a compact eyeglass-like form factor.

In some embodiments, the light engine is a digital light processing-based projector, a micro-projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode). The light engine is communicatively coupled to the controller and a non-transitory processor-readable storage medium or a memory that stores processor-executable instructions and other data that, when executed by the controller, cause the controller to control the operation of the light engine.

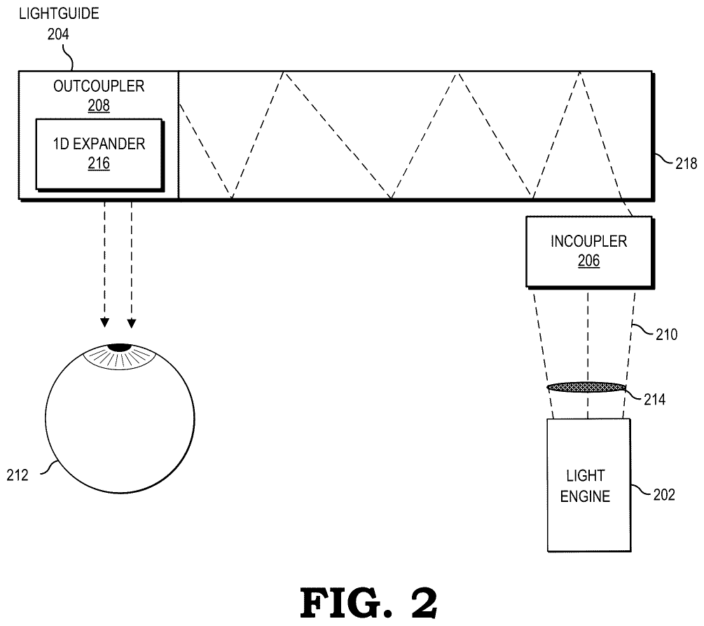

FIG. 2 illustrates a simplified block diagram of a projection system 200 that projects images directly onto the eye of a user via display light. The projection system 200 includes a light engine 202 and a lightguide 204. The term “lightguide”, as used herein, will be understood to mean a combiner using one or more of total internal reflection (TIR), partial internal reflection (PIR), specialized filters, diffractive structures, and/or reflective surfaces to transfer light from an incoupler (e.g., incoupler 206) to an outcoupler 208. In at least some embodiments, the outcoupler 208 includes a 1D expander 216. In other embodiments, the 1D expander 216 replaces or works in conjunction with the outcoupler 208, or the outcoupler 208 itself includes the 1D expander 216. In some display applications, the light is a collimated image, and the lightguide transfers and replicates the collimated image to the eye. In some embodiments, the projection system 200 is implemented in a HWD, NED, or other display system, such as the display system 100 of FIG. 1.

The light engine 202 includes one or more display light sources configured to generate and output display light 210 (e.g., visible display light such as red, blue, and green display light and/or non-visible display light such as infrared display light) representing an image. In at least some embodiments, the light engine 202 is coupled to a driver or other controller (not shown), which controls the timing of emission of display light from the display light sources of the light engine 202 in accordance with instructions received by the controller or driver from a computer processor coupled thereto to modulate the display light 210 to be perceived as images when output to the retina of an eye 212 of a user. For example, during the operation of the projection system 200, multiple display light beams having respectively different wavelengths are output by the display light sources of the light engine 202, then combined via a beam combiner (not shown) before being directed to the eye 212 of the user. The light engine 202 modulates the respective intensities of the display light beams so that the combined display light reflects a series of pixels of an image, with the particular intensity of each display light beam at any given point in time contributing to the amount of corresponding color content and brightness in the pixel being represented by the combined display light at that time.

The display light 210 then travels to the lightguide 204, which includes or is otherwise connected to the incoupler 206, the 1D expander 216, and the outcoupler 208. In at least some embodiments, the collimator optic(s) 214 within the light engine 202 are configured to produce a sufficiently large second axis (e.g., vertical) pupil so that when the 1D expander 216 provides expansion along the first axis, the resultant eyebox is sizable in both first (e.g., horizontal) and second axis (e.g., vertical) dimensions (e.g., about 10 mm×10 mm or another dimension). In at least some embodiments, the collimator optic(s) 214, which may include curved lenses or other shaped optical elements, are integrated within the light engine 202. In other embodiments, the collimator optic(s) 214 may be located externally (e.g., downstream of the light engine 202) but still aligned with the light engine 202 to properly shape and direct the display light 210 into the lightguide 204.

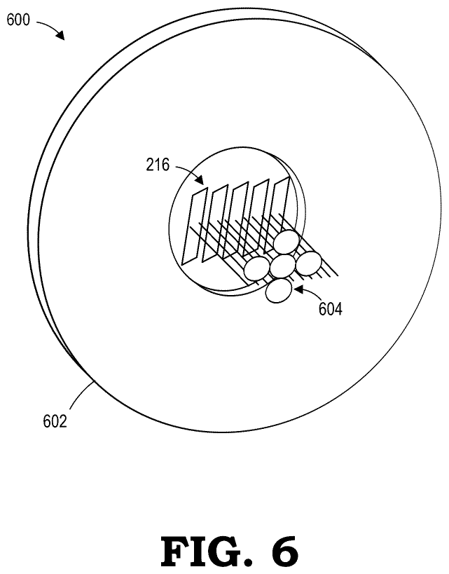

The incoupler 206 is configured to efficiently direct display light 210 into the body 218 of the lightguide 204. After receiving the display light 210, the incoupler 206 directs the light into the body 218 of the lightguide, where it propagates via TIR, PIR, or both. Rather than the pupil being formed at the incoupler location, the inclusion or use of the 1D expander 216 in conjunction with (or in place of) the outcoupler 208 causes the pupil to form within the middle region of the eyeglass-like structure, as shown in FIG. 6, providing a more uniformly accessible viewing area. The 1D expander 216 expands the light along the first axis to replicate the exit pupil across a wider area, thereby increasing the eyebox size and ensuring a more uniform viewing region for the user.

For example, FIG. 6 shows a perspective view of an eyeglass lens assembly 600 incorporating the 1D expander 216 with multiple reflective coatings embedded in the central region of the lens structure 602. In this configuration, the exit pupil is formed in the middle of the lens structure 602 rather than at the incoupler location. FIG. 6 further illustrates multiple spatial eyebox positions 604, demonstrating how the 1D expander effectively provides expansion along the first axis and stabilizes the eyebox. This ensures that, as the user's eye moves within these lateral positions, the user continues to perceive a uniform and high-quality image within the central portion of the lens structure 602. By expanding the light along the first axis via one or more prism arrays, the 1D expander 216 increases the eyebox size and ensures a wider, more uniform viewing area without degrading image quality. The 1D expander 216, in at least some embodiments, is fabricated using techniques such as molding or casting with partial mirror coatings and index-matched adhesives, thereby reducing manufacturing complexities while maintaining high optical performance.

Referring again to FIG. 2, after passing through the 1D expander 216, the display light continues through the lightguide 204 until it is directed out toward the user's eye. For example, the outcoupler 208, which includes or is replaced by the 1D expander 216, ensures the display light 210 is delivered to the user's eye 212 with minimal reflection and high transmission efficiency. The lightguide 204, with its integrated components such as the incoupler 206, the 1D expander 216, and the outcoupler 208, provides high optical efficiency and enhanced visual performance. In at least some embodiments, additional optical components, such as polarization films, may be included to further optimize image quality by reducing ghosting or enhancing uniformity. For example, a polarization film may be disposed on or near the outcoupler 208 to polarize the display light 210.

In at least some embodiments, the projection system 200 also includes additional components such as turning prisms to redirect display light or adjust the optical path. These components enable precise control over the propagation and delivery of display light, ensuring an optimal user experience in extended reality (XR) applications.

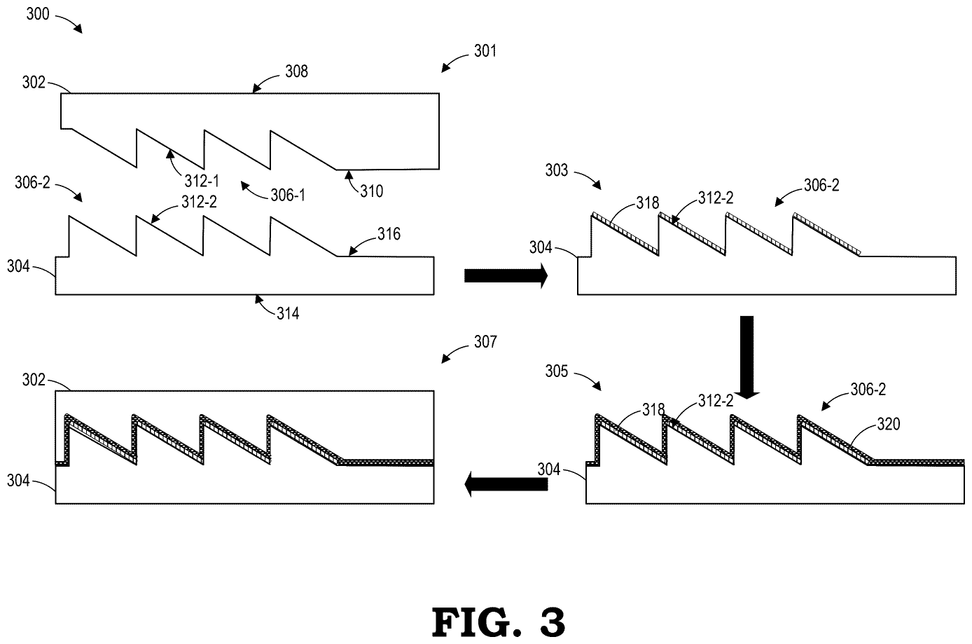

As described above, a 1D expander 216 is implemented in a display device, such as the display device 100 of FIG. 1, to increase the size of the exit pupil and ensure a wider and more uniform viewing area for the user. By expanding the light along the first axis through a prism array, the 1D expander 216 replicates the exit pupil, effectively enlarging the eyebox to accommodate varying eye positions and movements without degrading image quality. FIG. 3 illustrates a fabrication sequence 300 for creating the 1D expander 216 according to one or more embodiments. At step 301, a molding process is performed to form a first portion 302 (e.g., the top portion in the view depicted in FIG. 3) and a second portion 304 (e.g., the bottom portion in the view depicted in FIG. 3), which opposes the first portion 302, of the 1D expander 216. In at least some embodiments, the second portion 304 is complementary to the first portion 302. The terms “top” and “bottom” are used with respect to the orientation shown in FIG. 3 and are not intended to limit the physical orientation of the molds, which may be flipped or rotated during the molding process. In at least some embodiments, the molding process is performed using precision injection molding techniques to ensure accurate replication of the designed features and high-quality optical surfaces. The mold cavities are fabricated to include the intricate geometric details of prism array 306 (illustrated a prism array 306-1 and prism array 306-2) for each portion 302, 304.

In at least some embodiments, the first portion 302 of the 1D expander 216 is molded with a flat upper surface 308 for structural stability and an opposing patterned lower surface 310 featuring a plurality of facets 312 (illustrated as facets 312-1) of the corresponding prism array 306-1. These facets 312-1, in at least some embodiments, are triangular prism facets configured to interact with light by redirecting and expanding it along the first axis within the optical system. In other embodiments, the facets 312-1 have a different shape or configuration than the example illustrated in FIG. 1. The mold for the first portion 302 incorporates these prism facets 312-1 with high precision, ensuring that the angles and dimensions of each facet 312-1 meet the desired optical specifications. In at least some embodiments, during the molding process, the material (e.g., a transparent optical-grade polymer such as polycarbonate or PMMA (polymethyl methacrylate) is injected into the mold under controlled pressure and temperature conditions to ensure uniform filling and replication of the fine details. Cooling is managed to prevent defects such as warping or sink marks, which could affect the optical quality of the prism facets.

Similarly, the second portion 304 is molded with a complementary design. The second portion 304, in at least some embodiments, includes a flat base 314 for stability and an opposing patterned upper surface 316 with facets 312 (illustrated as facets 312-2) pointing towards (e.g., upward in the illustrated view) the facets 312-1 of the first portion 302. The facets 312-2 of the second portion 304 align precisely with the opposing facets 312-1 of the first portion 302. The molding process for the second portion 402 follows a similar injection molding approach as that described above for the first portion 302, ensuring that the facets 312-2 are accurately formed and that the two portions 302, 402 will fit together seamlessly during assembly. The complementary configuration ensures a precise mechanical fit between the top and bottom portions 302, 304, enabling proper bonding and alignment of the optical surfaces. As such, the result of the molding process is a pair of molded portions 302, 402 that serve as the foundation of the 1D expander.

In step 303, a partial mirror coating 318 is applied to the working facets 312 of at least one of the prism arrays 306, such as the prism array 306-2 of the second portion 304, to enable efficient light outcoupling within the 1D expander 216. In at least some embodiments, the partial mirror coating 318 is a thin, reflective layer selectively deposited on the angled surfaces of the bottom prism array 306-2, which serve as the working facets 312 of the 1D expander 216. This coating 318 is used to reflect and redirect light, ensuring proper light propagation and expansion along the first axis within the optical system. The term “partial” indicates that the coating reflects only a small fraction of the incoming light (for example, about 10%), with the remainder transmitted through the prism. By keeping the reflection percentage low, these partial mirrors remain discreet within the glasses, ensuring that they are not visible for cosmetic purposes.

The partial mirror coating 318, in at least some embodiments, is composed of high-performance reflective materials such as metal layers (e.g., aluminum, silver, or gold) or dielectric multilayers, depending on the specific optical and performance configuration of the 1D expander 216. Metal coatings, such as those made from aluminum or silver, are used due to their high reflectivity across a broad range of wavelengths, cost-effectiveness, and ease of application. Alternatively, dielectric coatings, which include multiple layers of thin films made from materials such as silicon dioxide (SiO₂), titanium dioxide (TiO₂), or magnesium fluoride (MgF₂), are employed to achieve wavelength-selective reflectivity and reduced optical losses.

In at least some embodiments, the application of the partial mirror coating 318 includes deposition techniques, such as physical vapor deposition (PVD), chemical vapor deposition (CVD), or sputtering. In PVD, the coating material is vaporized in a high-vacuum chamber and condensed onto the working facets of the prism array, forming a uniform reflective layer. In CVD, the coating material is introduced into a chamber in the form of precursor gases. These gases react chemically or decompose under controlled temperature and pressure conditions, causing the coating material to deposit onto the working facets of the prism array in a uniform layer. Sputtering bombards a target material with high-energy ions, causing atoms to be ejected and deposited onto the prism facets.

The coating 318, in at least some embodiments, is applied only to the working facets 312 by implementing masking techniques or selective deposition methods. For example, physical masks are placed over non-functional areas to protect them during the deposition process, or the coating apparatus is programmed to deposit material only on pre-defined regions of the prism array 306. This selective application ensures that the reflective coating enhances optical performance without interfering with transparency or adhesive bonding in subsequent steps.

In at least some embodiments, additional protective layers are applied over the partial mirror coating 318 to enhance durability and resistance to environmental factors, such as humidity, temperature changes, or mechanical abrasion. These protective layers can be transparent dielectric materials that preserve the coating's optical performance while extending its lifespan.

In step 305, an adhesive layer 320 is applied to at least one of the prism array 306 surfaces, such as the prism array 306-2 of the second portion 304, to enable the bonding of the first portion 302 and the second portion 304 of the 1D expander 216. The adhesive layer 320 does not interfere with the optical performance of the working facets 312, such as the reflection and refraction of light within the system. Various types of adhesives can be used, depending on the configuration of the 1D expander 216. Examples of adhesives include optical-grade adhesives, epoxy-based adhesives, UV-curable adhesives, silicone-based adhesives, a combination thereof, and the like. In at least some embodiments, the adhesive layer 320 is formed by applying the adhesive material to the surfaces of the prism array 306 using, for example, an automated dispensing system, such as syringes or jet dispensers, or another deposition process.

In step 307, the prism arrays 306 of the first portion 302 and the second portion 402 are aligned and bonded together to form the complete 1D expander 216. For example, once alignment is achieved, the two portions 302, 304 are pressed together. The adhesive layer 320 is activated or cured to create a strong, permanent bond between the top and bottom portions 302, 304. If a UV-curable adhesive is used, the assembled component is exposed to UV light for a specified duration to initiate the curing reaction. Alternatively, thermal curing may be performed in an oven to solidify epoxy-based adhesives.

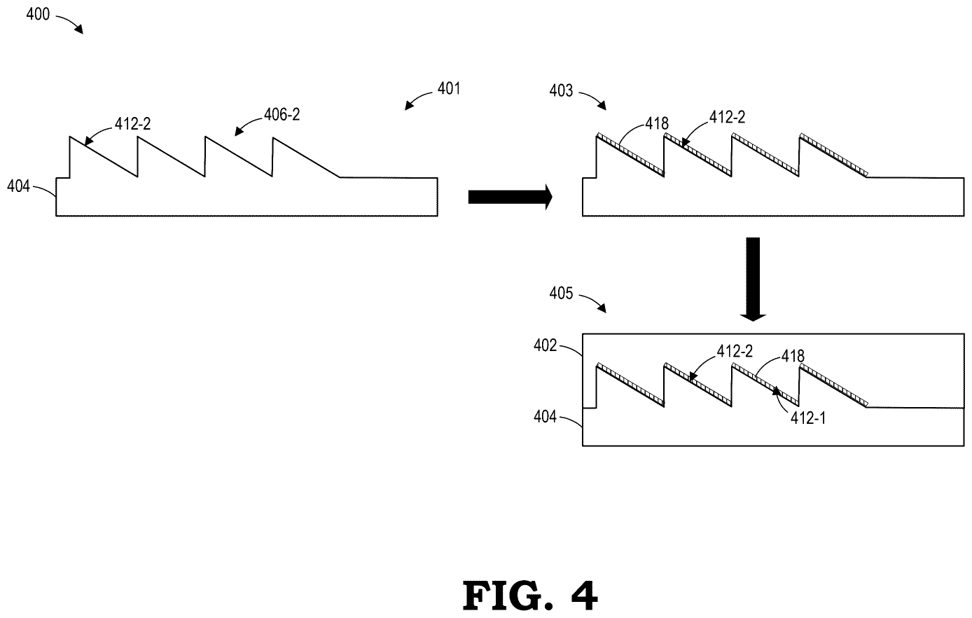

FIG. 4 illustrates another fabrication sequence 400 for creating the 1D expander 216 using a casting and overcasting/over-molding approach. This process differs from the process described in FIG. 3 and highlights a streamlined methodology to form the complete 1D expander with fewer bonding steps. In step 401, a casting or molding process is performed to fabricate the second portion 404 of the 1D expander. The molding process for the second portion 404 is similar to the molding process described above with respect to step 301 of FIG. 3, where the patterned surface featuring an upward-pointing prism array 406-2 is created. The prism array 406-2 includes triangular prism facets 412-2. However, unlike in FIG. 3, only the second portion 404 is molded in this step, as the subsequent steps will integrate the top structure during the overcasting process.

In step 403, a mirror coating 418 is deposited onto the working facets 412-2 of the second portion 404 of the 1D expander 216. This mirror coating process is also similar to that described above with respect to FIG. 3, where a partial reflective layer is selectively applied to the angled prism facets. In step 405, the first portion 402 of the 1D expander 216 is integrated with the second portion 404 through an overcasting or over-molding process. In this step, the first portion 402 of the 1D expander 216 is formed directly on the second portion 404 by, for example, injecting an optical-grade polymer into a mold that encapsulates the partially fabricated structure. An example of this overcasting process involves filling the mold cavity with molten material, ensuring that the material adheres to the second portion 404 and forms a seamless bond. During this step, the mold is configured to create the downward-pointing facets 412-1 of the first portion 402, which are aligned with the upward-pointing facets 412-2 of the second portion 404. The overcasting process eliminates the need for adhesive bonding between the two halves, providing a robust and optically aligned structure.

Both the processes described in FIG. 3 and FIG. 4 avoid the formation of sink marks, a common issue that arises during the molding of optical components due to differential cooling. Sink marks occur when the desired optical surfaces on the opposite side of molded features, such as the prism facets, become curved or distorted, leading to a need for additional polishing steps to restore flatness and optical precision. In the processes illustrated in FIG. 3 and FIG. 4, this complication is mitigated by employing materials and techniques that incorporate an index-matching adhesive or polymer. This index-matching approach eliminates the need for extensive polishing by compensating for any curvature or distortions introduced during the cooling phase. The adhesive or overcasting material fills voids and provides a uniform optical interface, preserving the integrity of the optical surfaces and ensuring that light propagates through the expander with minimal aberration.

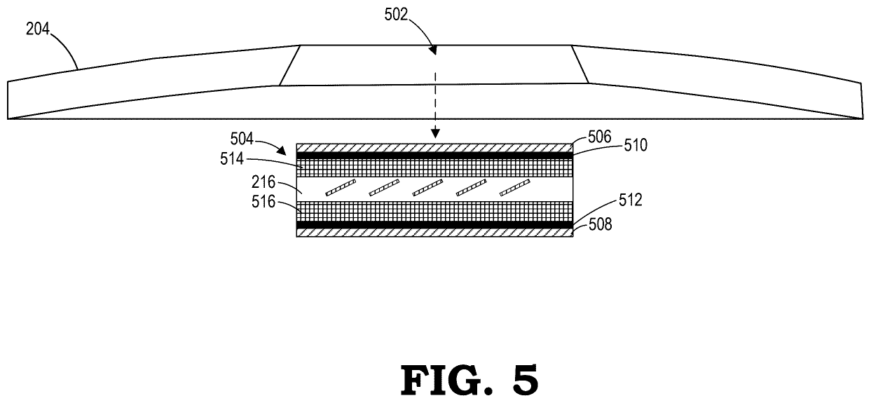

FIG. 5 illustrates a lightguide, such as the lightguide 204 of FIG. 2, that incorporates a region 502 comprising an optical structure 504 designed to facilitate efficient light manipulation and pupil expansion. As shown in the magnified 2D view of the optical structure 504 depicted in FIG. 2, optical structure 504 includes the 1D expander 216, a first filler layer 506, and a second filler layer 508, working in unison to achieve total internal reflection (TIR) within the pupil expansion region. The 1D expander 216 serves as the optical element responsible for expanding the light along the first axis, ensuring a wider and more uniform eyebox. The first filler layer 506 and the second filler layer 508 are positioned on opposite sides of the 1D expander 216, functioning as supporting optical elements that enhance the performance and manufacturability of the structure. For example, the first filler layer 506 is formed on a world-side surface, which is the surface that faces the external environment or the real world, of the first portion 302, 402 and the second filler layer 508 is formed on an eye-side surface, which is the surface closest to the user's eye or face, of the second portion 404. The filler layers include one or more materials, such as polycarbonate, polymethyl methacrylate, cyclo olefin polymer, glass, fused silica, hybrid polymers, silicone-based materials, a combination thereof, and the like.

In at least some embodiments, to facilitate TIR and minimize optical losses, the flat surfaces, such as those facing the 1D expander 216, of both the first and second filler layers 506, 508 are coated with a low-index material, such as chiolite, forming coatings 510, 512. These coatings create a cladding layer that ensures light remains confined within the pupil expansion region, reducing escape losses and improving optical efficiency. The incorporation of the first and second filler layers 506, 508 also serves to mitigate point variance (PV) errors that could otherwise impact the performance of the 1D expander. By providing a cladded environment for TIR, the coatings 510, 512 help maintain the integrity of light propagation, minimizing distortions and enhancing uniformity. The first and second filler layers 506, 508 also add structural stability to the assembly and allow for easier handling and integration during manufacturing.

The 1D expander 216, the first filler layer 506, the second filler layer 508, and the coatings 510, 512 are bonded together using an index-matched adhesive 514, 516. The use of index-matched adhesive ensures a seamless optical interface between the components, minimizing Fresnel reflections and preserving the desired optical paths. This adhesive layer also provides mechanical strength to the assembly, ensuring long-term stability and durability. Additionally, the first and second filler layers 506, 508, in at least some embodiments, are resurfaced, such as in cases where the first and second filler layers 506, 508 are molded thicker for easier manufacturing. This flexibility allows for adjustments during the assembly process to achieve precise optical tolerances and ensure the final structure meets design specifications.

As such, the 1D expander described herein offers significant advantages in optical systems, particularly in applications where efficient light manipulation and pupil expansion are desired. By expanding light along the first axis through prism arrays, the 1D expander ensures a wider and more uniform eyebox, enhancing the user experience by accommodating varying eye positions and movements without compromising image quality. The configuration of the 1D expander minimizes optical losses and aberrations, maintaining high brightness and uniformity across the display field of view. Additionally, the fabrication techniques for the 1D expander, whether using molding and bonding or casting and overcasting, address common manufacturing challenges such as sink marks and alignment errors, reducing production costs and complexity. The use of advanced materials, selective mirror coatings, and index-matched adhesives further enhances the structural integrity and optical performance of the 1D expander.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown other than as described in the claims below. It is, therefore, evident that the particular embodiments disclosed above may be altered or modified, and all such variations are considered within the scope of the disclosed subject matter. Accordingly, the protection sought herein is as set forth in the claims below.

What is claimed is:

1. A method of forming a one-dimensional (1D) expander, comprising:
forming a first portion and a second portion of the 1D expander, wherein the first portion comprises a first patterned surface and the second portion comprises a second patterned surface complementary to the first patterned surface;
applying a reflective coating to selected portions of at least one of the first patterned surface or the second patterned surface;
depositing an index-matched adhesive on at least one of the first patterned surface or the second patterned surface; and
bonding the first portion and the second portion together using the index-matched adhesive.

2. The method of claim 1, wherein forming the first portion and the second portion comprises:
molding the first portion and the second portion from an optical-grade polymer material.

3. The method of claim 1, wherein applying the reflective coating comprises:
applying the reflective coating to facets of the at least one of the first patterned surface or the second patterned surface.

4. The method of claim 1, further comprising:
bonding a first filler material on a first surface of the first portion; and
bonding a second filler material on a second surface of the second portion.

5. A method of forming a one-dimensional (1D) expander, comprising:
forming a first portion of the 1D expander by casting or molding the first portion, wherein the first portion comprises a first patterned surface;
applying a reflective coating to selected portions of the first patterned surface of the first portion; and
forming a second portion of the 1D expander directly on the first portion by overcasting or over-molding a second patterned surface complementary to the first patterned surface onto the first portion.

6. The method of claim 5, wherein forming the first portion comprises:
molding the first portion from an optical-grade polymer material.

7. The method of claim 5, wherein applying the reflective coating comprises:
applying the reflective coating to facets of the first patterned surface.

8. The method of claim 1, further comprising:
bonding a first filler material on a first surface of the first portion via a first indexed-matched adhesive layer; and
bonding a second filler material on a second surface of the second portion via a second indexed-matched adhesive layer.

9. A lightguide, comprising:
a one-dimensional (1D) expander configured to expand light within the lightguide along a first axis perpendicular to a second axis associated with the light, and further configured to increase a size of an exit pupil, the 1D expander comprising:
a first portion having a first patterned surface;
a second portion having a second patterned surface complementary to the first patterned surface;
a reflective coating formed on selected portions of at least one of the first patterned surface or the second patterned surface, the reflective coating configured to reflect light within the lightguide; and
a first filler layer formed on a world-side surface of the first portion;
a second filler layer formed on an eye-side surface of the second portion;
a first indexed-matched adhesive layer between the first filler layer and the world-side surface of the first portion; and
a second indexed-matched adhesive layer between the second filler layer and the eye-side surface of the second portion.

10. A near-eye display device comprising the lightguide of claim 9, and further comprising:
a support structure;
a lens supported by the support structure, the lens implementing the lightguide; and
a light engine configured to project display light for incoupling into the lightguide.
